(19) United States
(12) Patent Application Publication
(10) Pub. No.: US 2023/0082196 A1
(43) Pub. Date: Mar. 16, 2023

(54) RECYCLING METHOD OF POLYESTER COTTON BLENDED FABRIC

(71) Applicant: NAN YA PLASTICS CORPORATION, Taipei (TW)

(72) Inventors: Te-Chao Liao, TAIPEI (TW); Jung-Jen Chuang, TAIPEI (TW); Zhang-Jian Huang, TAIPEI (TW); Chung-Chi Su, TAIPEI (TW)

(73) Assignee: NAN YA PLASTICS CORPORATION, TAIPEI (TW)

(21) Appl. No.: 17/721,339

(22) Filed: Apr. 14, 2022

(30) Foreign Application Priority Data
Sep. 11, 2021 (TW) 110133886

(51) Int. Cl. D06M 13/188; D06P 5/13

(52) U.S. Cl. CPC D06M 13/188; D06P 5/131

(57) ABSTRACT

Provided is a recycling method of a polyester cotton blended fabric, including the following steps. A dye-containing polyester cotton blended fabric is put into an acidic aqueous solution containing an oxidizing agent for heating and soaking, so as to degrade the cotton in the polyester cotton blended fabric into powder, and decolorization is performed at the same time to remove the dye. After that, a polyester fabric and cotton powder are obtained by double filtration.

### CROSS-REFERENCE TO RELATED APPLICATION

This application claims the priority benefit of Taiwan application serial no. 110133886, filed on Sep. 11, 2021. The entirety of the above-mentioned patent application is hereby incorporated by reference herein and made a part of this specification.

### BACKGROUND

### Technical Field

The disclosure relates to a recycling method of a fabric, and particularly relates to a recycling method of a polyester cotton blended fabric.

### Description of Related Art

In a technology of recycling and reusing a polyester cotton blended fabric, separation and decolorization of cotton must be performed before the polyester and cotton in the blended fabric can be recycled and reused. In the separation procedure, conventionally, an organic acid aqueous solution is generally used to degrade the cotton to achieve separation. However, a dye may remain in the polyester fabric or the cotton after separation. Accordingly, the dye has to be removed for decolorization in order for the polyester and cotton to be recycled for use. As a result, costs are increased and the procedure becomes complex. In addition, in the case of using concentrated phosphoric acid to degrade cotton fibers in the polyester cotton blended fabric at high temperature, no effect will be produced on polyester fibers. Then, filtration and separation are performed to obtain the polyester fibers. However, a dye may still remain and further decolorization is necessary. In the case of using hydrochloric acid as a catalyst to degrade the cotton fibers in the polyester cotton blended fabric into cotton powder, separation can be achieved without affecting the polyester fibers. However, a dye may still remain and further decolorization is necessary.

In view of the above, a recycling method of a polyester cotton blended fabric has been developed in which separation and decolorization can be simultaneously performed, thereby reducing costs and procedure complexity. This is also a hot research topic at present.

### SUMMARY

The disclosure provides a recycling method of a polyester cotton blended fabric, in which an acidic aqueous solution containing an oxidizing agent is used for soaking, and separation and decolorization can be simultaneously performed, thereby reducing costs and procedure complexity.

A recycling method of a polyester cotton blended fabric according to the disclosure includes the following. A polyester cotton blended fabric containing a dye is put into an acidic aqueous solution containing an oxidizing agent for heating and soaking, so as to degrade the cotton in the polyester cotton blended fabric into powder, and decolorization is performed at the same time to remove the dye. After that, a polyester fabric and cotton powder are obtained by double filtration.

In an embodiment of the disclosure, the dye includes a physical dye or a chemical dye.

In an embodiment of the disclosure, the soaking is performed at a temperature higher than a glass transition temperature of polyester.

In an embodiment of the disclosure, the soaking is performed in the acidic aqueous solution at a temperature of 90° C. to 180° C.

In an embodiment of the disclosure, the acidic aqueous solution contains an organic acid. The organic acid is a monobasic acid, dibasic acid or acid anhydride having 1 to 18 carbons, and examples thereof include formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid or cyclohexanecarboxylic acid.

In an embodiment of the disclosure, the concentration of the organic acid in the acidic aqueous solution is 0.5 wt % to 10 wt %.

In an embodiment of the disclosure, the concentration of the oxidizing agent in the acidic aqueous solution is 0.05 wt % to 1.0 wt %.

In an embodiment of the disclosure, a weight ratio between the polyester cotton blended fabric and the acidic aqueous solution is 1:8 to 1:30.

In an embodiment of the disclosure, the soaking is performed for 0.5 hour to 3 hours.

In an embodiment of the disclosure, the oxidizing agent includes hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium salts of perborate, sodium dichromate, dichromate, or a combination thereof.

In an embodiment of the disclosure, the double filtration includes first filtration and second filtration. The first filtration uses a filter having a mesh size of 1 mm to 30 mm, and the second filtration uses a filter having a mesh size of 10 μm to 100 μm.

In an embodiment of the disclosure, the polyester fabric as obtained has an L value of 80% or more, an a value of −3 to 3, and a b value of −6 to 6.

Based on the above, the disclosure provides a recycling method of a polyester cotton blended fabric, in which an acidic aqueous solution containing an oxidizing agent is used for soaking, so as to degrade the cotton into powder and remove a dye from the polyester fabric at the same time. Since the polyester and cotton can be separated and decolorized polyester fibers and cotton powder can be obtained in a single process, costs are reduced and the procedure is simplified. The quality of recycled polyester fabric can be improved and the application field thereof can be expanded, which is advantageous for subsequent mechanical or chemical recycling of polyester fibers.

### DESCRIPTION OF EMBODIMENTS

Hereinafter, embodiments of the disclosure will be described in detail. However, these embodiments are illustrative, and the disclosure is not limited thereto.

In the present specification, a range represented by “a numerical value to another numerical value” is a schematic representation for avoiding listing all of the numerical values in the range in the specification. Therefore, the recitation of a specific numerical range covers any numerical value in the numerical range and a smaller numerical range defined by any numerical value in the numerical range, as is the case with any numerical value and a smaller numerical range thereof in the specification.

The disclosure provides a recycling method of a polyester cotton blended fabric, including the following steps. A polyester cotton blended fabric containing a dye is put into an acidic aqueous solution containing an oxidizing agent for heating and soaking, so as to degrade the cotton in the polyester cotton blended fabric into powder, and decolorization is performed at the same time to remove the dye. After that, a polyester fabric and cotton powder are obtained by double filtration.

In the present embodiment, the dye may include a physical dye or a chemical dye. The acidic aqueous solution contains an organic acid. The organic acid is a monobasic acid, dibasic acid or acid anhydride having 1 to 18 carbons, and examples thereof include formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid or cyclohexanecarboxylic acid. The concentration of the organic acid in the acidic aqueous solution is, for example, 0.5 wt % to 10 wt %, preferably 1.0 wt % to 8.0 wt %. The oxidizing agent in the acidic aqueous solution may include hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium salts of perborate, sodium dichromate, dichromate, or a combination thereof. The concentration of the oxidizing agent is, for example, 0.05 wt % to 1.0 wt %, preferably 0.1 wt % to 0.8 wt %, and costs may be reduced.

In the present embodiment, a weight ratio between the polyester cotton blended fabric and the acidic aqueous solution is, for example, 1:8 to 1:30, preferably 1:10 to 1:15. The polyester cotton blended fabric containing the dye is put into the acidic aqueous solution containing the oxidizing agent for heating and soaking. The heating and soaking are preferably performed at a temperature higher than a glass transition temperature of the polyester, such that the dye can be released into the acidic aqueous solution and be removed at the same time. For example, the soaking is performed in the acidic aqueous solution at a temperature of 90° C. to 180° C., preferably 100° C. to 160° C. The soaking is performed for, for example, 0.5 hour to 3 hours, preferably 1 hour to 2 hours.

The polyester cotton blended fabric contains impurities such as a dye and a surface treatment agent. The cotton may be degraded into powder by the acidic aqueous solution while the polyester fabric maintains its structure, and the impurities such as the dye may be removed under the oxidizing agent and the acidic environment. After the dye is removed or decolorized, double filtration is performed to obtain a white polyester fabric and white cotton powder. The L value of the polyester fabric is increased from 20% to 80% or more, the a value is −3 to 3, and the b value is −6 to 6. L, a, and b are three basic color coordinates of a color space commonly used to describe all the colors visible to the human eye. The L value indicates brightness (L=0% indicates black and L=100% indicates white). The a value indicates a position between red and green (a negative a value indicates green and a positive a value indicates red). The b value indicates a position between yellow and blue (a negative b value indicates blue and a positive b value indicates yellow). The higher the L value of a recycled fabric, the brighter the fabric appears, which is relatively advantageous for the quality of downstream dyeing and finishing of the fabric (cloth). In the double filtration, first filtration uses a filter having a mesh size of 1 mm to 30 mm. Preferably, a filter made of metal, for example, is used to separate the polyester fabric and cotton powder aqueous solution slurry from each other. After that, the cotton powder aqueous solution slurry is subjected to second filtration using a filter having a mesh size of 10 μm to 100 μm. Preferably, a filter made of plastic, for example, is used to separate the cotton powder and water from each other so as to obtain the cotton powder. By the recycling method of a polyester cotton blended fabric according to the disclosure, in the case of an aqueous solution, a decrease in the IV (molecular weight) of the polyester is within 10%.

The recycling method of a polyester cotton blended fabric according to the disclosure is described below in detail by way of experimental examples. However, the following experimental examples are not intended to limit the disclosure.

### EXPERIMENTAL EXAMPLE

In order to verify that the recycling method of a polyester cotton blended fabric according to the disclosure achieves both separation and decolorization, and that the polyester and cotton can be separated and decolorized polyester fibers can be obtained in a single process, the experimental examples are provided as follows.

### Example 1

25 g of a polyethylene terephthalate (PET) polyester-cotton blended fabric (having an L value of 20%, in which the PET polyester accounted for 76% of the weight and the cotton accounted for 24% of the weight) was taken and put into a 1 L pressure-resistant reaction tank, and 500 ml of water, 25 g of maleic acid, and 1.5 g of sodium hypochlorite were put therein, followed by stirring at 135° C. for 2 hours to degrade the cotton into cotton powder.

After that, the resultant was cooled to 80° C., the PET polyester and cotton powder slurry were separated by a 3 mm sieve screen, and the PET polyester fabric was washed with 100 ml of water. Then, the cotton powder slurry was passed through a filter having a mesh size of 20 μm to separate the cotton powder and the aqueous solution from each other.

The PET polyester fabric was dried at 105° C. for 2 hours to obtain a PET fabric of 99.5% purity by weight and having an L value of 82%, an a value of 0.9, and a b value of 5.2.

The purity by weight was measured in the following manner. 600 cc of sulfuric acid aqueous solution having a concentration of 75% by weight was poured into a 1000 cc Erlenmeyer flask, and 3 g of a PET fabric sample after separation was taken and put into the flask. The flask was heated to 50° C.±5° C. and maintained for 1 hour during which the flask was shaken every 10 minutes. Upon completion, the resultant was subjected to pumping and drainage using a funnel equipped with a 3 mm sieve screen. 200 cc of sulfuric acid aqueous solution having a concentration of 75% by weight was poured into the funnel to wash the fabric, and the resultant was subjected to pumping and drainage. Then, 200 cc of clean water was poured into the funnel to wash the fabric twice, and each time the resultant was subjected to pumping and drainage. The PET fabric was dried in an oven at 105° C. for 2 hours, then weighed to 2.986 g, and the purity by weight was determined to be 99.5%. The above method was adopted in the following other examples and comparative examples, and description thereof will not be repeated.

### Example 2

By following the same procedure as in Example 1 except that oxalic acid was used in place of maleic acid, a PET fabric was obtained having a purity by weight of 99.8%, an L value of 85%, an a value of 0.1, and a b value of 4.4.

### Example 3

By following the same procedure as in Example 1 except that calcium hypochlorite was used in place of sodium hypochlorite, a PET fabric was obtained having a purity by weight of 99.4%, an L value of 88%, an a value of 0.4, and a b value of 2.6.

### Example 4

25 g of a PET polyester-cotton blended fabric (having an L value of 20%, in which the PET polyester accounted for 48% of the weight and the cotton accounted for 52% of the weight) was taken and put into a 1 L pressure-resistant reaction tank, and 500 ml of water, 30 g of formic acid, and 1.5 g of sodium hypochlorite were put therein, followed by stirring at 150° C. for 2 hours to degrade the cotton into cotton powder.

After that, the resultant was cooled to 80° C., the PET polyester and cotton powder slurry were separated by a 3 mm sieve screen, and the PET polyester fabric was washed with 100 ml of water. Then, the cotton powder slurry was passed through a filter having a mesh size of 20 μm to separate the cotton powder and the aqueous solution from each other.

The PET polyester fabric was dried at 105° C. for 2 hours to obtain a PET fabric of 99.2% purity by weight and having an L value of 85%, an a value of 1.9, and a b value of 4.2.

### Example 5

By following the same procedure as in Example 4 except that oxalic acid was used in place of formic acid, a PET fabric was obtained having a purity by weight of 99.9%, an L value of 85%, an a value of 1.8, and a b value of 4.9.

### Example 6

By following the same procedure as in Example 4 except that 2.5 g of sodium hypochlorite was used in place of 1.5 g of sodium hypochlorite, a PET fabric was obtained having a purity by weight of 99.9%, an L value of 89%, an a value of −0.1, and a b value of 3.3.

### Comparative Example 1

25 g of a PET polyester-cotton blended fabric (having an L value of 20%, in which the PET polyester accounted for 76% of the weight and the cotton accounted for 24% of the weight) was taken and put into a 1 L pressure-resistant reaction tank, and 500 ml of water and 25 g of maleic acid were put therein, followed by stirring at 135° C. for 2 hours to degrade the cotton into cotton powder.

After that, the resultant was cooled to 80° C., the PET polyester and cotton powder slurry were separated by a 3 mm sieve screen, and the PET polyester fabric was washed with 100 ml of water. Then, the cotton powder slurry was passed through a filter having a mesh size of 20 μm to separate the cotton powder and the aqueous solution from each other.

The PET polyester fabric was dried at 105° C. for 2 hours to obtain a PET fabric of 99.2% purity by weight and having an L value of 54%, an a value of 3.8, and a b value of 6.4.

### Comparative Example 2

25 g of a PET polyester-cotton blended fabric (having an L value of 20%, in which the PET polyester accounted for 48% of the weight and the cotton accounted for 52% of the weight) was taken and put into a 1 L pressure-resistant reaction tank, and 500 ml of water and 30 g of formic acid were put therein, followed by stirring at 150° C. for 2 hours to degrade the cotton into cotton powder.

After that, the resultant was cooled to 80° C., the PET polyester and cotton powder slurry were separated by a 3 mm sieve screen, and the PET polyester fabric was washed with 100 ml of water. Then, the cotton powder slurry was passed through a filter having a mesh size of 20 μm to separate the cotton powder and the aqueous solution from each other.

The PET polyester fabric was dried at 105° C. for 2 hours to obtain a PET fabric of 99.2% purity by weight and having an L value of 63%, an a value of 4.9, and a b value of 8.2.

According to the above experimental results, in Examples 1 to 6 which employed the recycling method of a polyester cotton blended fabric according to the disclosure, an acidic aqueous solution containing an oxidizing agent was used for soaking. Thus, a polyester fabric having an L value of 80% or more can be obtained. In contrast, in Comparative Examples 1 and 2 which did not employ an oxidizing agent, a polyester fabric having an L value of 80% or more was not obtained. The higher the L value of a recycled fabric, the brighter the fabric appears, which is relatively advantageous for the quality of downstream dyeing and finishing of the fabric (cloth). By adding an oxidizing agent having a concentration of 0.3% by weight to the process and under acidic conditions, it is possible to effectively remove a coloring matter such as a dye from a PET fabric, so that the fabric can appear white (having an L value of 80% or more) and have an a value of −3 to 3 and a b value of −6 to 6. As the concentration of the oxidizing agent is increased to 1.0 wt %, the a and b values approach 0. As the concentration of the oxidizing agent is decreased to 0.05 wt %, the absolute value of a approaches 3, and the absolute value of b approaches 6.

In summary, the disclosure provides a recycling method of a polyester cotton blended fabric which achieves both separation and decolorization. In the recycling method, an acidic aqueous solution containing an oxidizing agent is used for soaking, so as to degrade the cotton into powder and remove a dye from the polyester fabric at the same time. The polyester and cotton can be separated and decolorized polyester fibers can be obtained in a single process. Compared to the conventional technology in which cotton must be first degraded to obtain a polyester fabric and a dye in the polyester fabric is then removed by solvent extraction for decolorization, the costs can be reduced and the procedure can be simplified. Moreover, the polyester fabric as obtained has high quality, high safety and low cost. In this way, the quality of recycled polyester fabric is improved and the application field thereof is expanded, which is advantageous for subsequent mechanical or chemical recycling of polyester fibers.

What is claimed is:

1. A recycling method of a polyester cotton blended fabric, comprising:
putting a polyester cotton blended fabric containing a dye into an acidic aqueous solution containing an oxidizing agent for heating and soaking, so as to degrade cotton in the polyester cotton blended fabric into powder, and performing decolorization at the same time to remove the dye; and
obtaining a polyester fabric and cotton powder by double filtration.

2. The recycling method of a polyester cotton blended fabric according to claim 1, wherein the dye comprises a physical dye or a chemical dye.

3. The recycling method of a polyester cotton blended fabric according to claim 1, wherein the soaking is performed at a temperature higher than a glass transition temperature of polyester.

4. The recycling method of a polyester cotton blended fabric according to claim 1, wherein the soaking is performed in the acidic aqueous solution at a temperature of 90° C. to 180° C.

5. The recycling method of a polyester cotton blended fabric according to claim 1, wherein the acidic aqueous solution contains an organic acid, the organic acid is a monobasic acid, dibasic acid or acid anhydride having 1 to 18 carbons, and the organic acid comprises formic acid, acetic acid, acetic anhydride, oxalic acid, propionic acid, malonic acid, butyric acid, succinic acid, valeric acid, glutaric acid, caproic acid, adipic acid, isooctanoic acid, citric acid, maleic acid, maleic anhydride, benzoic acid or cyclohexanecarboxylic acid.

6. The recycling method of a polyester cotton blended fabric according to claim 5, wherein a concentration of the organic acid in the acidic aqueous solution is 0.5 wt % to 10 wt %.

7. The recycling method of a polyester cotton blended fabric according to claim 1, wherein a concentration of the oxidizing agent in the acidic aqueous solution is 0.05 wt % to 1.0 wt %.

8. The recycling method of a polyester cotton blended fabric according to claim 1, wherein a weight ratio between the polyester cotton blended fabric and the acidic aqueous solution is 1:8 to 1:30.

9. The recycling method of a polyester cotton blended fabric according to claim 1, wherein the soaking is performed for 0.5 hour to 3 hours.

10. The recycling method of a polyester cotton blended fabric according to claim 1, wherein the oxidizing agent comprises hydrogen peroxide, potassium permanganate, calcium hypochlorite, ozone, nitric acid, nitrate, sodium chlorate, calcium chlorate, chlorates, perchlorate, sodium hypochlorite, hypochlorite, sodium perborate, sodium salts of perborate, sodium dichromate, dichromate, or a combination thereof.

11. The recycling method of a polyester cotton blended fabric according to claim 1, wherein the double filtration comprises first filtration and second filtration, the first filtration uses a filter having a mesh size of 1 mm to 30 mm, and the second filtration uses a filter having a mesh size of 10 μm to 100 μm.

12. The recycling method of a polyester cotton blended fabric according to claim 1, wherein the polyester fabric as obtained has an L value of 80% or more, an a value of −3 to 3, and a b value of −6 to 6.
